(19) United States
(12) Patent Application Publication
(10) Pub. No.: US 2007/0286174 A1
(43) Pub. Date: Dec. 13, 2007

(54) System and apparatus for incorporating voice over internet protocol (VoIP) adapter functionnality into a cordless telephone system

(76) Inventors: Michael H. Brannan, Alpharetta, GA (US); David L. Ellis, Liburn, GA (US)

Correspondence Address: GENERAL INSTRUMENT CORPORATION DBA THE CONNECTED;HOME SOLUTIONS BUSINESS OF MOTOROLA, INC., 101 TOURNAMENT DRIVE, HORSHAM, PA, 19044, US

(21) Appl. No.: 11/449,920

(22) Filed: Jun. 9, 2006

(51) Int. Cl. H04L 12/66

(52) U.S. Cl. 370/356

(57) ABSTRACT

A system (50) including a telephone device having incorporated therein voice over Internet protocol (VoIP) adapter functionality. The system includes a VoIP adapter for coupling to a network, such as an Internet protocol (IP) network, and a telephone device, such as a cordless telephone device, for coupling to the VoIP adapter. The telephone device includes a base station and a plurality of handsets, such as cordless handsets. The telephone device is configured to include therein VoIP adapter functionality, such as subscriber integrated circuit (SLIC) functionality that conventionally resides in a conventional VoIP adapter. The incorporation of SLIC functionality and other VoIP adapter functionality into the telephone device reduces the overall cost of the system, e.g., by eliminating relatively expensive hardware, such as SLICs, and also reduces the relative complexity of the system, e.g., by simplifying several system component hardware configurations.

### BACKGROUND OF THE INVENTION

1. Field of the Invention

The invention relates to cordless telephones and other telephones used in voice over Internet protocol (VoIP) telephony. More particularly, the invention relates to cordless telephones with base stations having incorporated therein VoIP adapter functionality.

2. Description of the Related Art

A conventional voice over Internet protocol (VoIP) telephone system having one or more cordless telephones typically includes one or more cordless base stations connected to a VoIP analog telephone adapter (ATA). The VoIP adapter transforms conventional voice data into digital signals suitable for transmission over an Internet protocol (IP) network or other computer network. Typically, the VoIP adapter has a plurality of analog interfaces, such as analog RJ-11 jacks, for connecting the VoIP adapter to a plurality of cordless telephone base stations and other conventional analog telephones. The VoIP adapter also includes one or more digital interfaces for connecting to an IP network or other network, e.g., via a cable modem, or to a network device, such as a computer, a laptop or a wireless handheld device.

Many conventional VoIP telephone adapters can support multiple lines, but such adapters usually require relatively expensive hardware in the form of a subscriber line integrated circuit (SLIC) for each of the multiple lines that are to interface with the conventional cordless telephone and other telephones. Each SLIC performs many tasks, including detecting when a caller picks up or hangs up the receiver, ringing the telephone when required, and powering the telephone if the telephone is a non-cordless telephone.

### BRIEF DESCRIPTION OF THE DRAWINGS

FIG. 1 is a block diagram of a conventional voice over Internet protocol (VoIP) system including one or more cordless telephones; and

FIG. 2 is a block diagram of a VoIP system including a cordless telephone having incorporated therein VoIP adapter functionality.

### DETAILED DESCRIPTION

In the following description, like reference numerals indicate like components to enhance the understanding of the graphics scaling method and apparatus through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

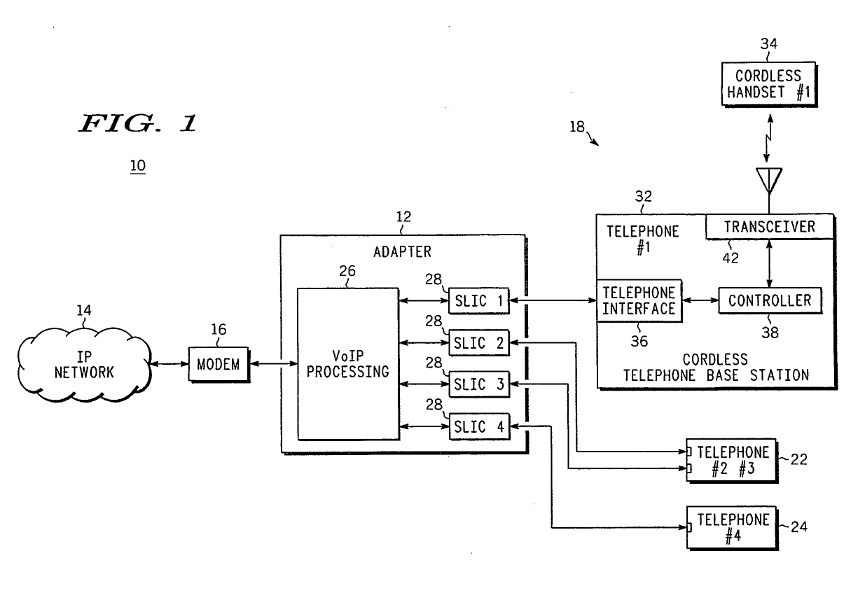

Referring now to FIG. 1, shown is a block diagram of a conventional voice over Internet protocol (VoIP) telephone system 10. The system 10 includes a VoIP adapter 12 coupled to a network, such as an Internet protocol (IP) network 14. The VoIP adapter 12 is coupled to the network in any suitable manner, e.g., via a modem 16 or other suitable connection. The system 10 also includes one or more telephone devices coupled to the VoIP adapter 12. The telephone devices can be any suitable telephone devices, such as a cordless telephone device 18, a multiple line telephone device 22 and/or a single line telephone device 24. The multiple line telephone device 22 can be a wired telephone device or a cordless telephone device, or any other suitable type of telephone device. Similarly, the single line telephone device 24 can be a wired or cordless telephone device, or other suitable type of telephone device.

The VoIP adapter 12 includes VoIP processing 26 and a plurality of subscriber line integrated circuits (SLIC) 28 coupled to the VoIP processing 26. The VoIP processing 26 typically includes a digital interface (not shown) for coupling the VoIP adapter 12 to the IP network 14, e.g., via the modem 16. In general, the VoIP processing 26 converts conventional voice data traffic received from the one or more telephone devices 18, 22, 24 into digital signals suitable for transmission over the IP network 14. The VoIP processing 26 also converts digital voice traffic signals from the IP network 14 into analog voice data traffic suitable for transmission to the one or more telephone devices 18, 22, 24 that are coupled to VoIP adapter 12.

As mentioned previously herein, the VoIP adapter 12 also includes a plurality of subscriber line integrated circuits (SLICs) 28 coupled to the VoIP processing 26. A conventional VoIP adapter typically includes an SLIC for each telephone line that the VoIP adapter is capable of supporting. For example, the VoIP adapter 12 shown in the VoIP system 10 is configured to support four (4) individual telephone lines. Although some telephone devices have multiple telephone lines, e.g., the dual line telephone device 22, the VoIP adapter 12 still needs four (4) SLICs 28 to support the four (4) telephone lines in the system 10. As shown, the first SLIC (SLIC 1) 28 is coupled to the telephone device 18, the second and third SLICs (SLIC 2 and SLIC 3) 28 both are coupled to the multiple line telephone device 22, and the fourth SLIC (SLIC 4) 28 is coupled to the single line telephone device 24.

Typically, for an associated telephone device to which the SLIC is coupled, the SLIC detects when a caller picks up or hangs up the telephone device's receiver, and rings the telephone device when a call is coming into the telephone device. Also, the telephone device is a non-cordless telephone device, the SLIC coupled thereto provides power to the telephone device. Each SLIC typically connects to its associated telephone device via an analog interface, using any suitable connection, such as an analog RJ-11 jack. As shown, for connections to multiple line telephone devices (e.g., telephone device 22), each SLIC connects individually to a separate input interface or port of the telephone device.

The cordless telephone device 18 typically includes a base station 32 and one or more handsets 34. The base station 32 typically includes a telephone interface 36 for coupling the telephone device 18 to the VoIP adapter 12 and one of the SLICs 28, a processor or controller 38 coupled to the interface 36, and a transceiver 42 coupled to the controller 38. The controller 38 includes the hardware and/or software necessary to communicate voice data traffic to and from the base station 32, more specifically between the interface 36 and the transceiver 42. The transceiver 42 transmits and receives voice data traffic, in the form of radio frequency (RF) signals, to and from the handset 34.

As discussed previously herein, conventional VoIP telephone adapters, such as the VoIP adapter 12, can support multiple lines using a corresponding plurality of SLICs, but such hardware configuration is relatively expensive. However, as will be discussed in greater detail hereinbelow, by integrating most of the SLIC interface functionality into a single cordless telephone base station that supports multiple cordless telephone handsets, multiple telephone lines can be bridged throughout the cordless telephone system in a relatively convenient and inexpensive manner.

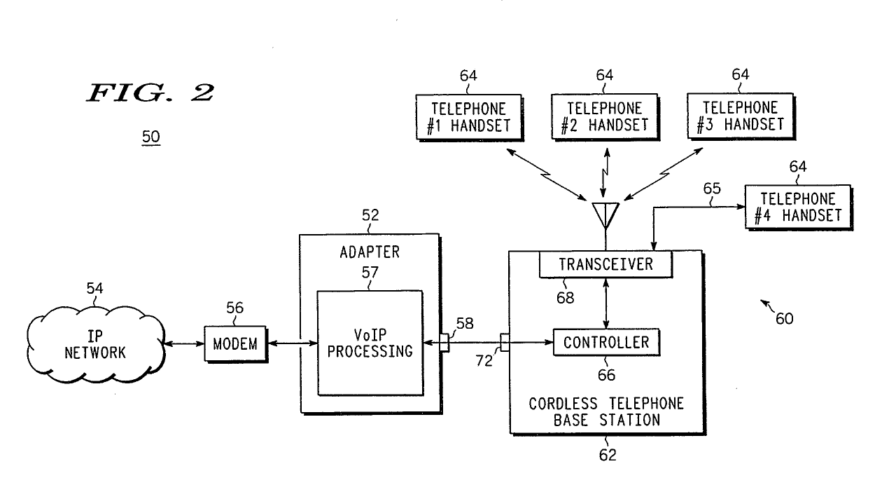

Referring now to FIG. 2, shown is a block diagram of a VoIP system 50 including a cordless telephone device having incorporated therein VoIP adapter functionality. The system 50 includes a VoIP adapter 52 coupled to a network, such as an Internet protocol (IP) network 54, e.g., via a modem 56. The VoIP adapter 52 includes VoIP processing 57 and a digital port or other appropriate interface 58 for coupling to one or more telephone devices. Compared with conventional VoIP adapters, the VoIP adapter 52 in the system 50 does not includes any SLICs.

The system 50 also includes at least one telephone device 60 coupled to the VoIP adapter 52. The telephone device 60 can be a cordless telephone device that includes a base station 62 and one or more handsets 64 associated with the base station 62 and wirelessly coupled thereto. Alternatively, one or more of the handsets 64, e.g., the fourth handset (telephone #4 handset), can be coupled to the base station using a wired connection 65.

The base station 62 includes a controller 66 and a transceiver 68. The base station 62 also includes a digital port or other appropriate interface 72 coupled to the controller 66. The digital interface 72 is used for coupling the base station 62 to the VoIP adapter 52. As will be discussed in greater detail hereinbelow, each of the handsets 64 can be associated with a different telephone number. That is, the base station 62 is configured to support multiple telephone handsets that each have a different telephone number associated therewith.

The telephone device 60 can be partially or completely configured in the form of hardware circuitry and/or other hardware components within a larger device or group of components. Alternatively, the telephone device 60 can be partially or completely configured in the form of software, e.g., as processing instructions and/or one or more sets of logic or computer code. In such configuration, the logic or processing instructions typically are stored in a data storage device (not shown), which typically is coupled to a processor or controller, such as the controller 66. The controller 66 accesses the necessary instructions from the data storage device and executes the instructions or transfers the instructions to the appropriate location within the telephone device 60.

One or more of the controller 66 and the transceiver 68 can be comprised partially or completely of any suitable structure or arrangement, e.g., one or more integrated circuits. Also, it should be understood that the telephone device 60 includes other components, hardware and software (not shown) that are used for the operation of other features and functions of the telephone device 60 not specifically described herein.

In the system 50, the base station 62 is configured in such a way that at least a portion of the functionality of a conventional VoIP adapter, e.g., the VoIP adapter 12, is incorporated into at least the controller 66. For example, the controller 66 includes at least a portion of the functionality of one or more SLICs, such as the SLICs 28 in the conventional VoIP adapter 12 in the conventional system 10 shown in FIG. 1. Also, in the system 50, the base station 62 is configured to support multiple telephone handsets that each can have one or more different telephone numbers associated therewith. Thus, in the system 50, the base station 62 includes the functionality of multiple telephone devices, such as the telephone devices 18, 22, 24 in the conventional system 10 shown in FIG. 1.

The base station 62 can be configured in such a way that each of the handsets 64 can have associated therewith one or more different telephone numbers. Moreover, each of the handsets 64 can have associated therewith one set of telephone numbers for incoming calls and a different set of telephone numbers for outgoing calls.

For example, the base station 62 can be configured in such a way that the first handset (telephone handset #1) rings for incoming calls and has access to four different telephone numbers, e.g., telephone numbers 1, 2, 3 and 4, and can make outgoing calls, i.e., get a dial tone, for telephone numbers 1, 2, 3 and 4. Similarly, the base station 62 can be configured in such a way that the second handset (telephone handset #2) rings for incoming calls only to telephone number 2, and can make outgoing calls only for telephone number 2. However, the base station 62 also can be configured in such a way that the third handset (telephone handset #3) rings for incoming calls and has access to telephone numbers 1 and 2, but can make outgoing calls only for telephone numbers 3 and 4. Alternatively, the base station 62 can be configured in such a way that the fourth handset (telephone handset #4) rings for incoming calls and has access to telephone numbers 1, 2, 3 and 4, but can make outgoing calls only for telephone number 2.

By incorporating such functionality into the base station 62 and at least the controller 66, the system 50 can support multiple telephone lines within a VoIP system arrangement in a more cost effective and less complex manner, compared to conventional VoIP systems. For example, configuring at least the controller 66 in this manner eliminates the need for a plurality of SLICs in the VoIP adapter. As shown in the system 50, the VoIP adapter 52 does not include any SLICs. Because of the relative expense associated with an SLIC, especially multiple SLICs, eliminating a plurality of SLICs from any component with a VoIP system, such as the VoIP adapter, reduces the overall cost of the system.

Also, with the removal of the multiple SLICs from the VoIP adapter and the use of a base station that is configured to support multiple telephone handsets that each can have one or more different telephone numbers associated therewith, there is no need for multiple ports and corresponding lines between the VoIP adapter and the base station of the telephone device. In the system 50, the ability to handle and support multiple telephone devices having one or more different telephone numbers associated therewith is accomplished using the controller 66 in the base station 62 and a single line coupled between the digital interface 58 of the VoIP adapter 52 and the digital interface 72 of the base station 62.

In a conventional VoIP system, e.g., the system 10 shown in FIG. 1, each SLIC 28 converts digital data traffic, such as voice data traffic, received from the IP network 54 and the VoIP processing 26 to analog data traffic before transmitting such data traffic to the analog port of the appropriate telephone device 18, 22, 24. However, in the VoIP system 50 shown in FIG. 2, with no SLICs in the VoIP adapter, digital data traffic received from the IP network 54 can be transmitted directly, in digital form, from the VoIP adapter 52 (the VoIP processing 57) to the base station 62 between the digital port 58 and the digital port 72. Any digital to analog conversion can be performed in the base station 62, e.g., by the controller 66, or in the handset 64.

Alternatively, instead of the VoIP adapter 52 and the base station being coupled together via respective digital port 58 and digital port 72, the VoIP adapter 52 and the base station 62 can be physically attached to one another. In this manner, the connection between the digital port 58 of the VoIP adapter 52 and the digital port 72 of the base station 62 is eliminated.

The overall complexity of the VoIP system 50 also is simplified by the ability of the base station 62, via the controller 66 and the transceiver 68, to route data traffic associated with any one of a plurality of telephone numbers to the appropriate handset 64 associated with the particular telephone number. The controller 66 includes the appropriate hardware and/or software to instruct the transceiver 68 which telephone handset to route the voice data traffic, based on the telephone number associated with the voice data traffic. The transceiver 68 also includes the appropriate hardware and/or software to route or direct the voice data traffic appropriately, e.g., by modulating the data traffic at the appropriate frequency for the data's intended handset 64.

The protocols used to implement all or a portion of the system 50 may include one or more of the following: cordless telephony protocols, such as but not limited to Digital Enhanced Cordless Telephony (DECT), mobile telephony call signaling, e.g., the integrated dispatch enhanced network (iDEN) Network, time division multiple access (TDMA), time division multiple access (CDMA), CDMA-2000, and global system for mobile communications (GSM); IP-based Telephony Signaling, e.g., Packet Cable Network-based Call Signaling (NCS), Packet Cable Duos, session initiation protocol (SIP), simple gateway control protocol (SGCP), media gateway control protocol (MGCP) and any protocol in accordance with the H.323 standard; the Public Switched Telephone Network (PSTN); and local network interfaces that support voice and data traffic, such as but not limited to Bluetooth™, and any protocols in accordance with the following standards: IEEE 802.11b, IEEE 802.11a, IEEE 802.11g, IEEE 802.11h, IEEE 802.11e and HomeRF™. The system 50 also can apply to handsets that can connect to a wired local network in accordance with the Home Phoneline Networking Alliance (HPNA), the Home Plug Powerline Alliance, 10/100BaseT Ethernet, universal serial bus (USB) and IEEE 1394, broadband networking including hybrid-fiber coax network, which includes Data Over Cable Service Interface Specification (DOCSIS) compliant protocols and IP Telephony protocols, Digital Subscriber Line (DSL) Modems and Networks, Fixed Wireless Networks (e.g., multichannel multipoint distribution service (MMDS) and local multipoint distribution service (LMDS)), Bluetooth™ Protocol Specification, and PacketCable™ and Network-Based Call Signaling Protocol Specification (NCS). Those skilled in the art will recognize that all or a portion of the system 50 may be implemented using virtually any type of local area network protocol currently existing or to be developed in the future.

The VoIP telephone device and system described herein may be implemented in a general, multi-purpose or single purpose processor. Such a processor will execute instructions, either at the assembly, compiled or machine-level, to perform that process. Those instructions can be written by one of ordinary skill in the art following the description of the data traffic routing method described herein and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the system and apparatus for incorporating VoIP adapter functionality into a cordless telephone system herein described without departing from the spirit and scope of the invention as defined by the appended claims and their full scope of equivalents.

1. A voice over Internet protocol (VoIP) telephone network system, comprising:
at least one VoIP adapter having a first side for coupling to an Internet protocol (IP) network and a second side; and
at least one telephone device coupled to the second side of the VoIP adapter, the telephone device including
a base station configured to receive data traffic from the VoIP adapter associated with a plurality of different telephone numbers, and
at least one handset corresponding to the base station and coupled thereto, wherein the at least one handset has corresponding thereto at least one of the plurality of different telephone numbers,
wherein the base station is configured to determine which data traffic is associated with which one of the plurality of different telephone numbers and to route the data traffic to the handset corresponding to the telephone number with which the data traffic is associated.

2. The system as recited in claim 1, wherein the at least one telephone device includes an individual port for coupling the at least one telephone device to the VoIP adapter, and wherein the telephone device is configured to receive and transmit data associated with the plurality of different telephone numbers via the individual port.

3. The system as recited in claim 1, wherein the at least one handset further comprises a plurality of handsets, and wherein at least one of the plurality of handsets corresponds to at least one of the plurality of different telephone numbers.

4. The system as recited in claim 1, wherein the at least one telephone device further comprises a cordless telephone device, and wherein the at least one handset is coupled to the base station cordlessly.

5. The system as recited in claim 1, wherein the at least one telephone device further comprises a wired telephone device, and wherein the at least one handset is coupled to the base station via a wired connection.

6. The system as recited in claim 1, wherein at least a portion of the at least one telephone device is implemented in software executed by a computer.

7. The system as recited in claim 1, wherein at least a portion of the at least one telephone device is implemented in hardware.

8. The system as recited in claim 1, wherein at least a portion of the at least one telephone device further comprises an integrated circuit.

9. A telephone device for use in coupling to a voice over Internet protocol (VoIP) adapter in a VoIP telephone network system, comprising:
a base station for coupling to the VoIP adapter; and
at least one handset coupled to the base station,
wherein the base station includes
a controller configured to receive data traffic from the VoIP adapter associated with a plurality of different telephone numbers, and
a transceiver coupled to the controller for transmitting and receiving between the base station and the at least one handset the data traffic received by the controller,
wherein the controller is configured to determine which data traffic is associated with which one of the plurality of different telephone numbers and to instruct the transceiver to route the data traffic to the handset corresponding to the telephone number with which the data traffic is associated.

10. The device as recited in claim 1, wherein the base station includes a port for coupling the base station to the VoIP adapter, and wherein the base station is configured to receive and transmit data associated with the plurality of different telephone numbers via the port.

11. The device as recited in claim 1, wherein the at least one handset further comprises a plurality of handsets corresponding to the plurality of different telephone numbers.

12. The device as recited in claim 1, wherein the telephone device further comprises a cordless telephone device, and wherein the at least one handset is coupled to the base station cordlessly.

13. The device as recited in claim 1, wherein the telephone device further comprises a wired telephone device, and wherein the at least one handset is coupled to the base station via a wired connection.

14. The device as recited in claim 1, wherein at least a portion of the controller is implemented in software executed by a computer.

15. The device as recited in claim 1, wherein at least a portion of the controller is implemented in hardware.

16. The device as recited in claim 1, wherein at least a portion of the controller further comprises an integrated circuit.

17. A computer program embodied in a computer-readable medium for coupling a telephone device to a voice over Internet protocol (VoIP) adapter in a VoIP telephone network system, the program comprising:
instructions for receiving by a base station portion of the telephone device data traffic from the VoIP adapter associated with a plurality of different telephone numbers;
instructions for determining which data traffic is associated with which one of the plurality of different telephone numbers;
instructions for transmitting from the base station portion of the telephone device to at least one handset portion of the telephone device corresponding to the base station the data traffic received by the base station, based on the telephone number with which the data traffic is associated, wherein the at least one handset has corresponding thereto one of the plurality of different telephone numbers,
wherein the at least one telephone device includes an individual port for coupling the base station portion of the telephone device to the VoIP adapter; and
instructions for receiving and transmitting via the individual port data associated with the plurality of different telephone numbers.
